(19) United States
(12) Patent Application Publication
(10) Pub. No.: US 2006/0277196 A1
(43) Pub. Date: Dec. 7, 2006

(54) Data management system, data server, data management method and storage medium thereof

(76) Inventors: Kengo Oosawa, Kawasaki-shi (JP); Akira Sunada, Kawasaki-shi (JP); Sunao Hashimoto, Kawasaki-shi (JP)

Correspondence Address: GAUTHIER & CONNORS, LLP, 225 FRANKLIN STREET, SUITE 2300, BOSTON, MA, 02110, US

(21) Appl. No.: 11/256,008

(22) Filed: Oct. 21, 2005

(30) Foreign Application Priority Data
Jun. 2, 2005 (JP) 2005-162642

(51) Int. Cl. G06F 17/30

(52) U.S. Cl. 707/10

(57) ABSTRACT

A data management system having a plurality of data servers connected via a network is provided, wherein each data server includes: a data management section that manages a data item in correspondence to a local identifier of the data item and a global identifier of the data item; a request processor section that searches the data management section for a data item requested from a client, provides the requested data item to the client when the requested data item is found, and transmits a data inquiry containing a global identifier of the requested data item to other data server to detect a data server which stores the requested data item when the requested data item is not found; and a response section that searches, when receiving a data inquiry from another data server, the data management section for a data item corresponding to a global identifier contained in the data inquiry and transmits a result of the search to the another data server.

### BACKGROUND OF THE INVENTION

1. Field of the Invention

The present invention relates to a technique for resolving a location of a data item requested by a user.

2. Description of the Related Art

Conventionally, in this field, a data management system manages files by assigning to each file a unique identifier called a “handle.” The data management system provides to a user, as a URL (Uniform Resource Locator) of a file, not a URL showing the location (combination of a located server and a path name of the file within the server) of the file, which is conventionally common, but a virtual URL designating the server name of the system and the handle of the file. When the user accesses the system by use of the virtual URL, the system identifies the location of the file from the handle and provides the file to the user. With this mechanism, even when the file is moved to an arbitrary location (directory) on the data management system, the file can be found in response to a request from a user.

In another related-art technique, a server assigns an identifier to each content item which is managed by the server and provides to a user a virtual URL containing the identifier of the content item matching a request when the user makes the request for search. When the user accesses the server by use of the virtual URL, the server transfers the identifier contained in the virtual URL to a storage system. The storage system copies to a cache memory the content item corresponding to the identifier and returns to the server an address of the copy of the content item on the cache memory. In this manner, the server can provide the content item on the cache memory to the user.

In a data management system “Dspace,” which is an open-source software developed by the Massachusetts Institute of Technology (MIT), a handle server is provided at a center which manages the handles (identifiers) of the data items and information of the server which manages each data item. Each DSpace platform resolves the server managing the actual data item corresponding to a handle provided by the user, by means of inquiring the handle server of the handle).

The first and second related-art techniques described above are limited to resolving locations of files and content items managed within one data management system, and cannot handle a situation, for example, in which the locations of the files and content items are changed (files and content items are moved) within multiple data management systems on a network.

Although the DSpace system can handle these cases, because the DSpace system completely depends on the central management server, problems unique to centralized control systems occur; for example, a data item on a server which is not registered in the central management server cannot be resolved, and the location of the data item cannot be resolved when the central management server fails.

### SUMMARY OF THE INVENTION

The present invention resolves location of a data item, even when the data item is moved to another server, by use of location information of the data item such as a URL issued before the data item is moved, without using a central management server.

According to an aspect of the invention, there is provided a data management system having a plurality of data servers connected via a network, wherein each data server includes: a data management section that manages a data item in correspondence to a local identifier of the data item and a global identifier of the data item; a request processor section that searches the data management section for a data item requested from a client, provides the requested data item to the client when the requested data item is found, and transmits a data inquiry containing a global identifier of the requested data item to other data server to detect a data server which stores the requested data item when the requested data item is not found; and a response section that searches, when receiving a data inquiry from another data server, the data management section for a data item corresponding to a global identifier contained in the data inquiry and transmits a result of the search to the another data server.

According to another aspect of the invention, there is provided a data server which forms a part of a data management system in cooperation with other data server connected via a network . The data server includes a data management section that manages a data item in correspondence to a local identifier of the data item and a global identifier of the data item; and a request processor section that searches the data management section for a data item requested from a client, provides the requested data item to the client when the requested data item is found, and transmits a data inquiry containing a global identifier of the requested data item to other data server to detect a data server which stores the requested data item when the requested data item is not found.

According to another aspect of the invention, there is provided a data management method executed by a data server which forms a part of a data management system in cooperation with other data server connected via a network. The method includes managing a data item in correspondence to a local identifier of the data item and a global identifier of the data item; searching for a data item requested from a client; providing the requested data item to the client when the requested data item is found; and transmitting a data inquiry containing a global identifier of the requested data item to other data server to detect a data server which stores the requested data item when the requested data item is not found.

According to another aspect of the invention, there is provided a storage medium readable by a computer. The storage medium stores a program of instructions executable by the computer to perform a function as a data server which forms a part of a data management system in cooperation with other data server connected via a network. The function includes: managing a data item in correspondence to a local identifier of the data item and a global identifier of the data item; searching for a data item requested from a client; providing the requested data item to the client when the requested data item is found; and transmitting a data inquiry containing a global identifier of the requested data item to other data server to detect a data server which stores the requested data item when the requested data item is not found.

### BRIEF DESCRIPTION OF THE DRAWINGS

An embodiment of the present invention will be described in detail by reference to the appended drawings, wherein:

FIG. 1 is a diagram schematically showing the structure of a data management system according to an embodiment of the present invention;

FIG. 2 is a diagram showing a structure of a data server according to an embodiment of the present invention;

FIG. 3 is a diagram showing a structure of management information of data in a data management section;

FIG. 4 is a diagram exemplifying a correspondence table stored in an ID conversion section;

FIG. 5 is a flowchart showing processing performed when a new data item is stored in a data management section;

FIG. 6a is a diagram exemplifying a virtual URL;

FIG. 6b is a diagram exemplifying a virtual URL;

FIG. 7 is a flowchart showing processing performed when a data server receives data request information from a client;

FIG. 8 is a flowchart showing processing performed by a data server when the data server receives an inquiry from another data server;

FIG. 9 is a diagram for explaining an operation of a system according to an embodiment of the present invention;

FIG. 10 is a diagram for explaining an operation of a system according to an embodiment of the present invention;

FIG. 11 is a diagram schematically showing a structure of a data server according to an alternative embodiment of the present invention;

FIG. 12 is a flowchart showing processing performed when a data server according to an alternative embodiment of the present invention receives data request information from a client; and

FIG. 13 is a diagram schematically showing a structure of a data server according to another alternative embodiment of the present invention.

### DETAILED DESCRIPTION OF THE INVENTION

An embodiment of the present invention will now be described by reference to the drawings.

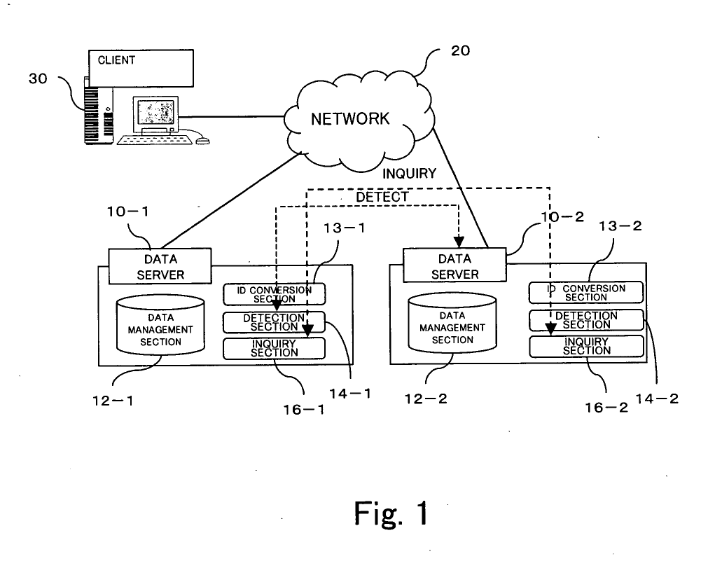

FIG. 1 is a diagram schematically showing the structure of a data management system according to an embodiment of the present invention. As shown in FIG. 1, the system includes multiple data servers 10-1, 10-2, . . . which are connected to a network 20 such as a LAN (Local Area Network) or the Internet (hereinafter, simply referred to as “data servers 10” unless the data server must be distinguished; the same applies to modules within the data server 10). The system provides a requested data item in response to a data request from a client 30 (for example, a personal computer) on the network 20.

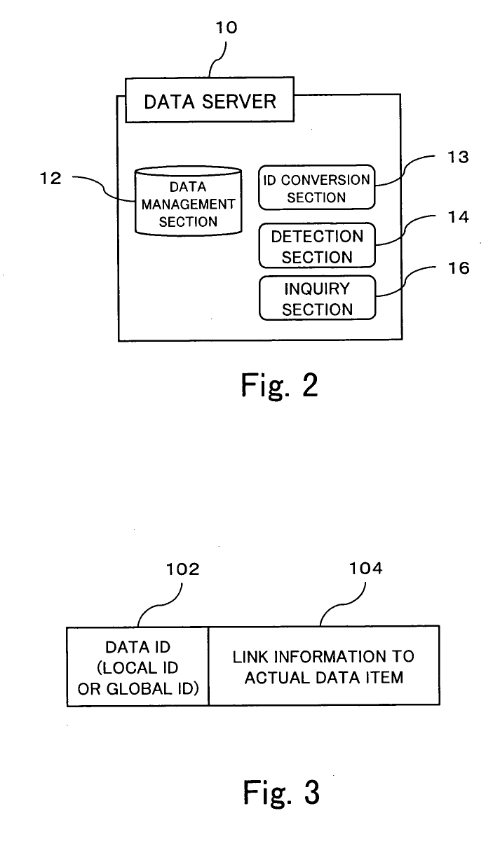

FIG. 2 schematically shows the structure of a data server 10 which is a part of the data management system according to the embodiment of the present invention. The data server 10 includes a data management section 12, an ID conversion section 13, a detection section 14, and an inquiry section 16. In the data management section 12, one or more data items (that is, objects) are stored and can be provided to the client 30 operated by a user. A globally unique global ID (identifier) and a local ID which is unique within the data server 10 are attached to each data item stored in the data management section 12.

For example, an identifier of 128 bits known as UUID (Universally Unique IDentifier) or GUID (Globally Unique IDentifier) may be used as the global ID. The UUID contains information of the time of creation of the UUID, a MAC (Media Access Control) address of a network card equipped in a machine used for creation of the UUID, etc., for assuring global uniqueness. The URL (Uniform Resource Locator) uniquely indicates a data item using a host name of the data server 10 having the data item and a path name indicating the location where the data item is actually stored in the data server 10, and the global ID of the present embodiment is an identifier independent from the information of the location of the data item.

The local ID, on the other hand, only needs be unique among data items stored in the data management section 12. Therefore, as compared with the global ID, the local ID requires a smaller data item (smaller number of digits). In the embodiment, a local ID which is a combination of a type of data item (object) and a serial number is used as an example local ID. The type of the data item represents, for example, a type such as a document, a folder, or a directory. The serial number may be, for example, a number attached in the order of storage to the data management section 12. The order may be assigned for each type of the data item. For example, the local ID of a document which is stored tenth would be “Document-10.” The local ID which is a combination of the type of the data item and the serial number is advantageous in that the data management section can automatically create the local ID and the user can remember the local ID relatively easily, thereby allowing easy input.

FIG. 3 shows a data structure of management information of each data item managed by the data management section 12. As shown in FIG. 3, the data management section 12 manages each stored data item by correlating a data ID 102 of the data item and link information 104 (for example, the path name of the data item) which indicates the data item within the data server 10. The data ID 102 may be a local ID or a global ID, is desirably the local ID having a smaller number of digits, in view of efficiency of a data search process.

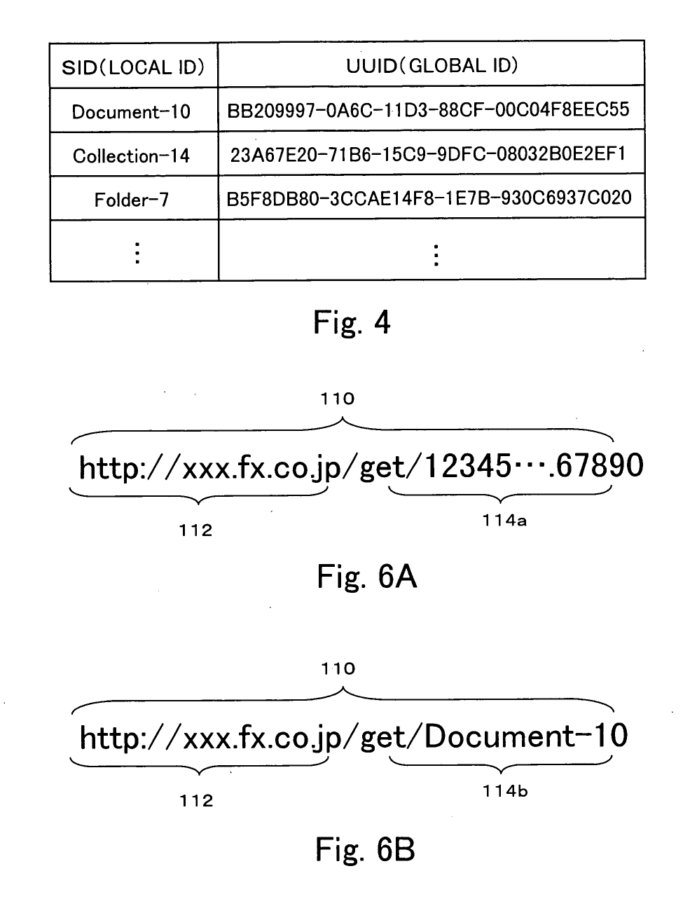

The ID conversion section 13 performs an ID conversion process between the global ID and the local ID. The ID conversion section 13 has a correspondence table showing a correspondence between the global ID and the local ID that are assigned to the same data item, in order to execute the conversion process. FIG. 4 exemplifies data contents in the correspondence table. For example, when a local ID is provided, the ID conversion section 13 uses the correspondence table to search for a global ID corresponding to the local ID. The ID conversion section 13 is not required to convert between the local ID and the global ID in both directions, but must be able to convert the local ID to the global ID, because the data server transmits an inquiry to another data server for a data item specified by the user using the local ID (details will be described later). When the data management section 12 manages the data items by use of the global ID, such a configuration is sufficient. When, on the other hand, the data management section 12 manages the data items using the local ID, and a data request which uses a global ID is to be accepted from the user, the conversion function for the opposite direction (that is, conversion from global ID to local ID) must be provided in the ID conversion section 13.

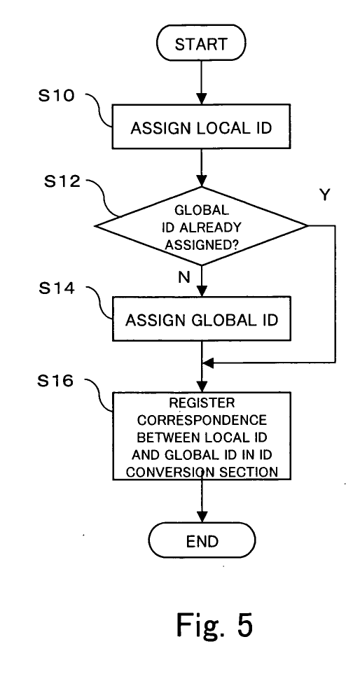

As shown in FIG. 5, when a new data item is to be stored in the data management section 12, the data server 10 assigns a local ID to the data item (S10) and checks whether or not the data item has a global ID assigned (S12). When the data item has an assigned global ID, the data server 10 stores the correspondence between the global ID and the local ID assigned in step S10 in the correspondence table of the ID conversion section 13 (S16). When the data item does not have an assigned global ID, the data server 10 assigns a global ID to the data item (S14) and stores the global ID and the local ID assigned in step S10 in the ID conversion section 13 (S16).

The information stored in the correspondence table of the ID conversion section 13 is not deleted even when the data item stored in the data management section 12 is deleted or moved to another data server, in order to facilitate data access by the user. It is also possible to employ a configuration wherein, when the data item stored in the data management section 12 is deleted, this event is recorded, for example, in correspondence to the local ID or global ID of the data item in the correspondence table.

The detection section 14 is a unit which detects another data server 10 present on the network 20.

The inquiry section 16 is a unit which transmits an inquiry to another data server 10 as to whether or not the other data server 10 has the data item requested from the client 30. The inquiry section 16 also has a function of responding to an inquiry from an inquiry section 16 of another data server 10.

In the present embodiment, when the client 30 operated by a user issues a request for a data item to the data management system, the client 30 issues the request using a virtual URL 110 as shown in FIG. 6a or 6b. The example virtual URL 110 shown in FIG. 6a is a virtual URL 110 including a host name 112 (this may alternatively be an IP address) of the data server 10 which manages the data item, and the global ID 114a of the data item. Because the number of digits of the global ID is very large, a portion of the global ID is omitted in FIG. 6a. The virtual URL shown in FIG. 6a indicates a data item managed by a data server called “xxx.fx.co.jp” and having a global ID of “12345 . . . 67890.” In the virtual URL of FIG. 6a, the term “get” between the host name 112 and the global ID 114a indicates a name of a method provided by the data server 10. When the data server 10 allows the client 30 to perform multiple types of operations with respect to the data items managed by the data server 10, the virtual URL is configured to contain the method indicating the operation. When, on the other hand, the data server 10 simply provides the requested data item to the client 30, such a description of method is not necessary. The example virtual URL shown in FIG. 6b is a virtual URL which includes a local ID 114b in place of the global ID 114a. The local ID 114b is a local ID of the data in the data server 10 having the data item when the virtual URL is issued.

Because the virtual URLs are URLs, each of the virtual URLs contains information on protocol, port, etc., but this will not be described here.

The virtual URL for accessing the data item is provided to the user by, for example, being included in an electronic mail or the like. The user attempts to access the data item through a web browser installed in the client 30 by operations such as clicking on the virtual URL.

It is also possible to provide a function of, when a change occurs in the data management section 12, such as a new data item is stored in the data management section 12 and the stored data item is updated, transmitting a notification of a virtual URL indicating the data item related to the change to the related user as a mechanism of notification of the virtual URL. The notification is transmitted in the form of, for example, an electronic mail. The virtual URL to be described in the notification may be a virtual URL using the global ID or a virtual URL using the local ID, but a local ID is desirable, in consideration of convenience to the user. The related user to which the notification is to be transmitted is registered in advance in the data server 10 in units of, for example, each data item, each folder, etc. It is also possible to employ a configuration of registering, when a user stores a data item in the data server 10, one or more persons for which access to the data item is permitted, as the notification transmission destination user(s).

In any of the above-described configurations, the user can access the data item using the virtual URL which has been obtained in the past.

When the user operates on the client 30 and requests a data item using the virtual URL 110, data request information containing the global ID 114a or the local ID 114b is transmitted to a data server indicated by the host name 112.

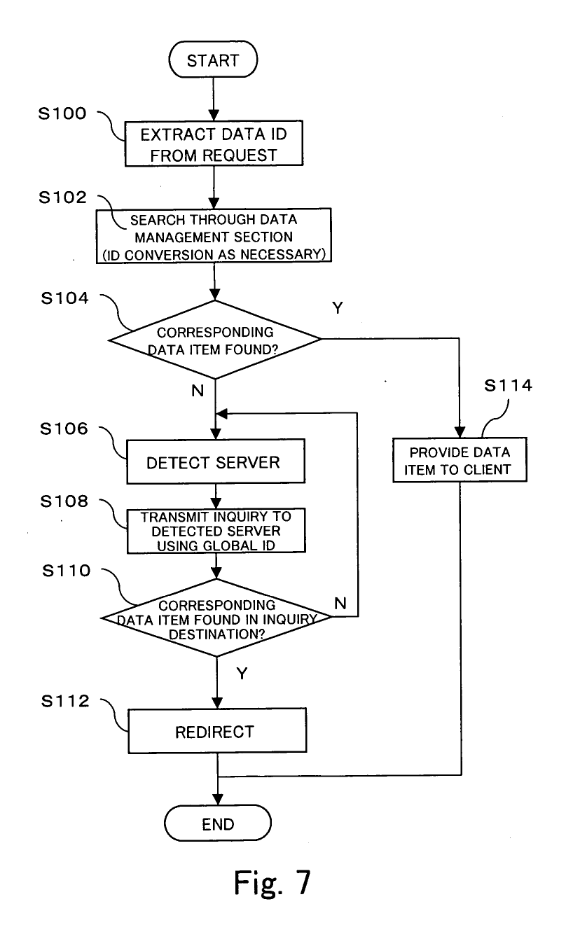

Next, processing performed when the data server 10 receives data request information from the client 30 will be explained by reference to FIG. 7. In the following description, for the sake of simplicity, the processing is explained as processing of one of the multiple data servers 10 forming a part of the system; that is, the data server 10-1, but the processing performed in the other data servers is similar to the described processing.

In this procedure, the data server 10-1 extracts the data ID from the data request information from the client 30 (S100) and searches the data management section 12-1 for link information of the actual data item corresponding to the data ID (S102) . In this process, in some cases a global ID 114a is extracted as the data ID and in other cases a local ID 114b is extracted from the data request which is performed using the virtual URL. In addition, the data management section 12-1 may have a structure which uses the global ID as the index of the stored data item or a structure which uses the local ID as the index. Therefore, in the search step S102, the ID conversion section 13-1 is used as necessary to convert the type of data ID indicated in the data request to a type of data ID of the search index of the data management section 12-1. For example, when the data management section 12-1 manages the data item using the local ID, and the data request which uses the global ID is transmitted from the client 30, the data management section 12-1 supplies the global ID to the ID conversion section 13-1 to convert the ID into a local ID, and a data item corresponding to the obtained local ID is searched. When the type of the data ID in the data request is identical with the ID type of the search index, the ID conversion process is not necessary. When the link information corresponding to the requested data item is found (when the determination result in step S104 is positive (Y)), the data server 10-1 obtains the actual data item indicated by the link information from a storage device within the data server 10-1 and provides the obtained data item to the client 30 (S114).

When, on the other hand, the link information corresponding to the requested data ID is not found (when the determination result in step S104 is negative (N)), the data server 10-1 instructs the detection section 14-1 to detect other data servers 10-2, etc. forming a part of the present system, and in response to the instruction the detection section 14-1 detects other data servers 10-2, etc. (S106) . The detection of the other data servers 10 can be achieved by, for example, the detection section 14-1 broadcasting to the network 20 a predetermined message for detecting other servers. The detection section 14-2, etc. of each of the data servers 10-2, etc. has a protocol to recognize the message for detecting other servers and respond to the message. In other words, according to the protocol, the detection section 14-2 of another data server 10-2 receiving the message for detecting other servers transmits a response, to the message, containing a server ID (identifier) of the data server 10-2. For example, an IP address or a host name may be used as the server ID. The detection section 14-1 which has transmitted the message for detecting other servers receives the response from the data server 10-2 and obtains the server ID contained in the response. In this manner, another data server 10-2 which is a part of the present system can be found.

When the other data server 10-2 is found, the data server 10-1 instructs the inquiry section 16-1 to transmit an inquiry to the found data server 10-2. In response to the instruction, the inquiry section 16-1 transmits to the data server 10-2 a data inquiry containing the global ID of the requested data item from the client 30 and inquires as to whether or not the data server 10-2 has the data item corresponding to the global ID (S108) . More specifically, the inquiry section 16 creates a data inquiry using the data ID in the data request from the client 30 when the data ID is a global ID or after converting the data ID to a global ID using the ID conversion section 13 when the data ID is a local ID. Details of an operation of the inquiry section 16-2 of the data server 10-2 receiving this inquiry will be described later.

When a result of the inquiry shows that the data server 10-2 to which the inquiry is transmitted does not have the data item (when the determination result of step S110 is negative (N)), the data server 10-1 repeats detection of another data server (SlO6) and transmission of an inquiry (S108). Steps S106 and S108 are repeated until a data server 10 having the data item is found.

Although FIG. 7 shows a procedure in which one data server is detected in step S106 and an inquiry is transmitted to the data server in step S108, the present invention is not limited to such a configuration, and it is also possible, for example, to detect all data servers 10 which can be detected through broadcasting in step S106, store the found data servers 10, and sequentially transmit the inquiry to each data server 10 in step S108.

When the results of inquiry show that the data server 10-2 to which the inquiry is transmitted has the data (when the determination result in step S10 is positive (Y)), the data server 10-1 returns to the client 30 redirect information containing the server ID of the data server 10-2 (S112). The return of the redirect information can be achieved, for example, according to a general redirect method of HTTP (HyperText Transfer Protocol) redirect method. That is, the data server 10-1 returns to the client 30 redirect information containing a status code indicating redirect such as 302 (found) and a location field containing the URL of the redirect destination. The URL of the redirect destination contained in the redirect information is the above-described virtual URL containing the server ID of the data server 10-2 which is the redirect destination and the data ID of the requested data item. The data ID in this process may be a global ID or a local ID, but the data ID is desirably a local ID, in view of convenience to the user. The local ID in this case is a local ID in the data server 10-2 which is determined to have the data.

When the virtual URL is a virtual URL having a global ID, because the server ID of the redirect destination and the global ID of the requested data item are already known during the inquiry, the data server 10-1 can create the virtual URL containing this information. When, on the other hand, the virtual URL is a virtual URL having a local ID, the local ID of the data is obtained from the inquiry destination data server 10-2 and the virtual URL is created by combining the local ID and the server ID.

The client 30 receiving the redirect information transmits a data request containing the data ID within the redirect information to the data server 10-2 indicated in the server ID also in the redirect information according to HTTP.

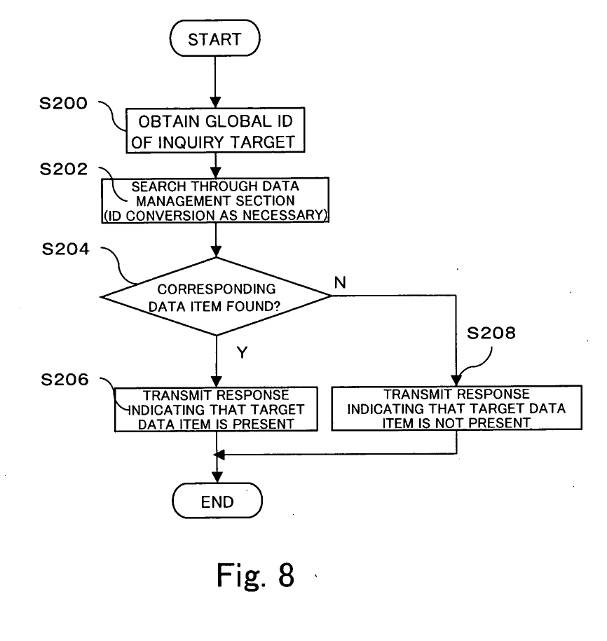

Next, processing performed by a data server when the data server receives an inquiry from another data server will be described by reference to FIG. 8. In the following description, for the sake of convenience the processing is described as processing of the data server 10-2, but the other data servers perform similar processing.

When the inquiry section 16 of the data server 10-2 receives a data inquiry from the inquiry section 16 of another data server 10-1, the inquiry section 16 extracts the global ID of the target data item from the information of the data inquiry (S200) and searches the data management section 12-2 for link information corresponding to the global ID (S202). In this search process, when the data management section 12-2 manages the data items using a local ID, the global ID is converted to the local ID using the ID conversion section 13-2 for the search. When the result of the search shows that the link information corresponding to the global ID is found in the data management section 12-2 (when the determination result of step S204 is positive (Y)), the inquiry section 16-2 returns to the data server 10-1 which has transmitted the inquiry a message indicating that the data server 10-2 has the data item which is the target of the inquiry (S206) . When, on the other hand, the link information is not found (when the determination result in step S204 is negative (N)), the inquiry section 16-2 returns to the data server 10-1 which has transmitted the inquiry a message indicating that the data server 10-2 does not have the data item which is the inquiry target (S208).

Alternatively, in step S206, instead of returning a message indicating that the data item which is the inquiry target is present to the inquiry origin, it is also possible to return the virtual URL of the data item which is the inquiry target (that is, the virtual URL containing the server ID of the data server 10-2 having the data item and the data ID of the data item) . A local ID may be used as the data ID shown in the virtual URL, as such a virtual ID is easily remembered and can be easily input by a user. When the present system provides the user with redirect information using the local ID, the inquiry section 16-2 returns to the data server 10-1 a virtual URL containing a local ID. When a virtual URL of the data item is returned from the inquiry destination data server 10-2 as described above, in step S112 the data server 10-1 which is the inquiry origin may return to the client 30, as the redirect information, the virtual URL provided by the data server 10-2.

An operation of the data management system as described above will now be described by reference to a specific example structure.

When the data server 10-1 has the target data item of the data request transmitted from the client 30 to the data server 10-1 in the structure of FIG. 1, the target data item is provided from the data server 10-1 to the client 30 according to the process shown in the above-described flowchart.

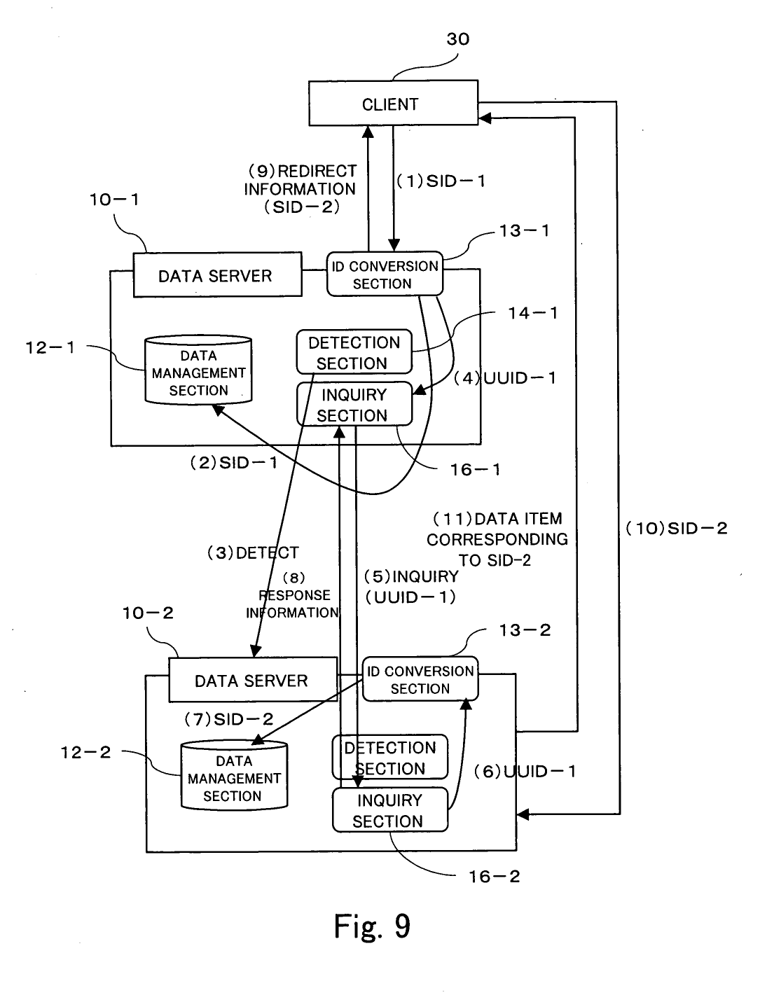

When, on the other hand, the target data item of the data request transmitted from the client 30 to the data server 10-1 is not present in the data server 10-1, the process proceeds, for example, in a manner as shown in FIG. 9. In the example configuration of FIG. 9, the data management sections 12-1 and 12-2 are assumed to manage data items using a local ID.

In FIG. 9, when a data request specifying the requested data item using a local ID (in FIG. 9, “SID-1”) is transmitted from the client 30 (1), the data server 10-1 searches the data management section 12 for data having the local ID “SID-1” (2). Because the data management section 12-1 does not have the data item in this example configuration, the detection section 14-1 detects another data server 10-2 (3) and determines a global ID corresponding to the local ID “SID-1” (in the example configuration, “UUID-1”) using the ID conversion section 13-1 (4) . If the requested data item has been stored in the data server 10-1 in the past, because a correspondence between the local ID of the data item and the global ID of the data item is registered in the ID conversion 13-1, the ID can be converted. When the user has received from the data server 10-1 or from another user a virtual URL indicating the data item, the data item is likely be stored in the data server 10-1 in the past. When the global ID of the requested data item “UUID-1” is determined, the inquiry section 16-1 transmits a data inquiry containing the global ID to the data server 10-2 (5).

The inquiry section 16-2 of the data server 10-2 receiving the data inquiry determines the local ID corresponding to the global ID “UUID-1” within the inquiry using the ID conversion section 13-2 (6). Because the data item of UUID-1 is stored in the data management section 12-2 in the exemplified configuration, the local ID corresponding to UUID-1 can be determined (“SID-2”) The data management section 12-2 searches the storage section of the data management section 12-2 for a data item corresponding to “SID-2” and transmits a search result to the inquiry section 16-2 (7). Because the data item having the local ID “SID-2” is found in the exemplified configuration, the inquiry section 16-2 returns to the inquiry section 16-1 of the data server 10-1 response information containing “SID-2” (8). The data server 10-1 receiving the response information creates redirect information containing “SID-2” and returns the redirect information to the requesting client 30 (9). The redirect information contains the host name of the data server 10-2 and the local ID “SID-2.” The client 30 accesses the data server 10-2 according to the redirect information (10) and obtains the data item “SID-2” (11).

In the example configuration of FIG. 9, the data management section 12 manages the data items using the local ID. When, on the other hand, the data management section 12 manages the data items using the global ID, the processing is similar to that shown in FIG. 9, except that the local ID in the data request must be converted to the global ID for the search process in the data management section 12 and that the data management section 12 can be searched using the global ID contained in the data inquiry when the data inquiry is received from another data server 10.

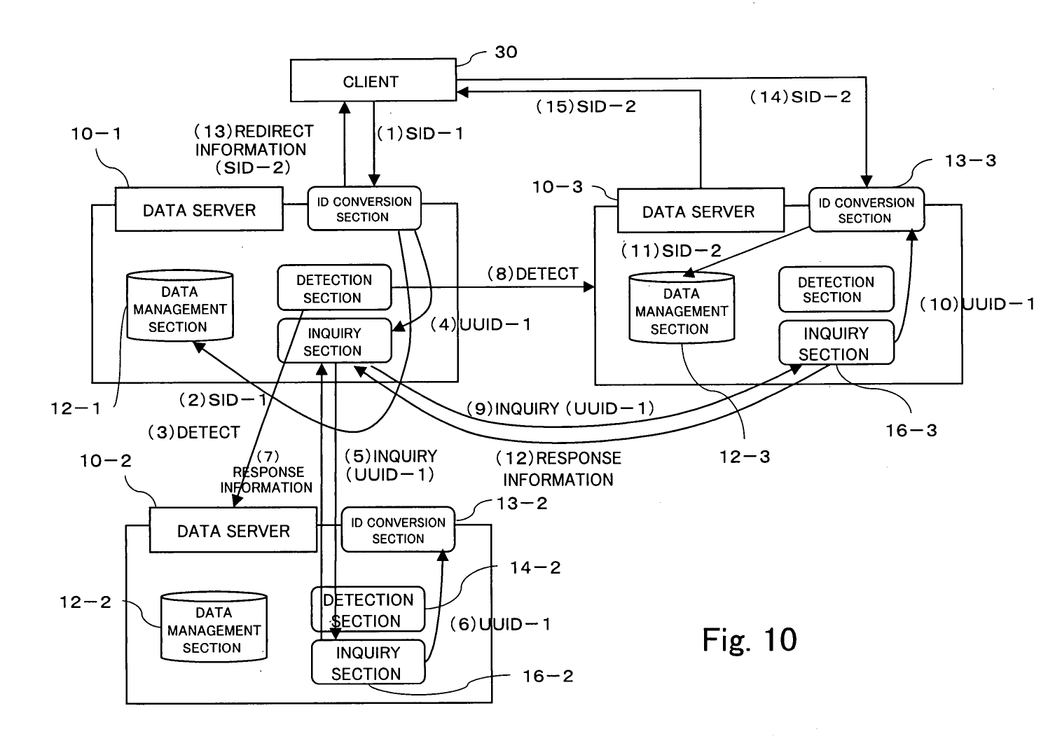

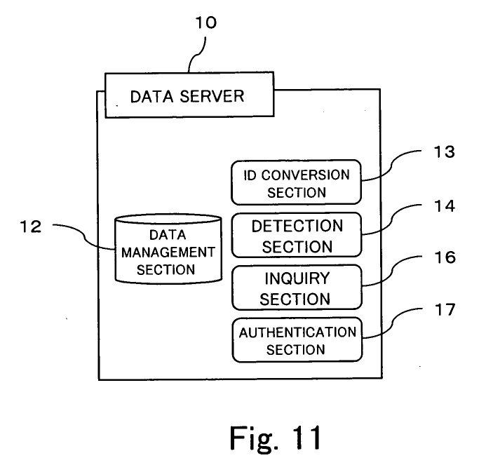

FIG. 10 shows a situation in which the data item requested by the client 30 is not present in the data server 10-1 or in the data server 10-2, but is present in a data server 10-3.

This situation is similar to that in FIG. 9 in terms of the processing by which the data server 10-1 detects the data server 10-2, the data inquiry is transmitted, and the inquiry section 16-2 inquires the ID conversion 13-2 for a local ID corresponding to the global ID of the inquiry “UUID-1” (6). In the situation of FIG. 10, however, the local ID corresponding to the global ID “UUID-1” is not obtained from the ID conversion section 13-2. This may occur when the data item has never been stored in the data server 10-2. In this case, the inquiry section 16-2 returns to the data server 10-1 response information indicating that the data server 10-2 does not have the data item related to the data inquiry (7).

Cases in which the data server 10-2 does not have the requested data item include, in addition to the case in which the data item has never been stored in the data server 10-2, cases in which the data item has been stored in the past, but has subsequently been moved or deleted. In such a case, the ID conversion section 13-2 has a local ID corresponding to UUID-1, but the data item is not found in the data management section 12-2. Therefore, in these cases also, the response information indicating that the data server 10-2 does not have the data item is returned to the data server 10-1.

From the response information, the inquiry section 16-1 of the data server 10-1 recognizes that the data server 10-2 does not have the requested data item. In this case, the detection section 14-1 detects another data server 10-3 (8) and transmits a data inquiry containing “UUID-1” (9). In the data server 10-3, “UUID-1” is converted to a local ID (“SID-2 ”) by the ID conversion section 13-3 (10) and the data management section 12-3 is searched using the local ID for the data item (11). In the exemplified configuration, the requested data item is found through the search. Therefore, the inquiry section 16-3 returns to the data server 10-1 response information containing the local ID “SID-2” (12). The subsequent processes are similar to those in the configuration of FIG. 9 (13-15).

In this manner, when the data server 10-1 does not have the data item requested by the client 30, the data server 10-1 transmits an inquiry to the other data servers 10-2, 10-3, . . . using the global ID of the data to inquire whether the data server has the requested data item. Therefore, when any of the data servers 10 has the data item, redirect information to that data server 10 is provided to the client 30 through the data server 10-1, and the client 30 can access the data item using the redirect information.

When the data server 10 which currently has the requested data item fails or the data item has been deleted, the data item cannot be found by searching on the network 20. Therefore, it is possible to employ a configuration in which the data server 10-1 receiving the data request from the client 30 completes transmission of an inquiry to another data server when a completion condition which has been set in advance is satisfied and the data server 10-1 responds to the client 30 indicating that the data item is not found. As the completion condition, there may be used, for example, (a) a condition that the requested data item is not found after transmitting a data inquiry to a designated number of data servers 10, the designated number having been designated in advance, (b) a condition that the requested data item is not found after a designated time elapses, the designated time having been designated in advance, and (c) a condition that the domain in which the data server 10 is searched is designated in advance and the requested data item is not found after all data servers 10 in the domain have been inquired. Alternatively, when a list on which server IDs of a portion or all of data servers in the data management system are registered is stored in the data server 10-1, the completion condition may be (d) a condition that the requested data item is not found after all data servers 10 on the list have been inquired.

A configuration in which, when a deletion operation of a data item is performed, the data management section 12 registers the deletion event in a deletion list in correspondence to the local ID or the global ID of the data item may be employed. In this case, the data server 10-2 transmits a response indicating that the data item has been deleted when the data item for which the data inquiry is transmitted from another data server 10-1 is on the deletion list. With this response, the data server 10 can quit further search processing and notify the client 30 that the requested data item has been deleted.

In the above explanation of the embodiment, an example configuration is described in which the data request using the local ID is received from the client 30. The present invention, however, is not limited to such a configuration, and it can easily be understood that a similar search process can be performed using the global ID.

As described, in the present embodiment, each data server 10 searches for other data server 10 which has the data item requested by the client 30 and redirects the request to the found data server 10. Therefore, because the requested data item can be found even when no central management server is provided, a problem that the data item cannot be resolved due to failure of a server can be significantly inhibited as compared with the related art.

In the present embodiment, even when the location of the data item changes as a result of the data item being moved between data servers 10, the client 30 can access the data item using the virtual URL which is already known, so that the data server 10 which originally managed the data item; that is, the data server 10 corresponding to the server ID within the virtual URL, receives the access request and searches for a data server 10 which currently stores the data item. Therefore, the client 30 can obtain the data item using the virtual URL which the client 30 already has.

Some known data servers have a function of, for example, distributing, to the user through an electronic mail, a URL on which a change can be checked when the data item on the server changes, such as when a data item is newly stored. When, however, the data item on the server is moved to another server, the distributed URL becomes unusable. When the mechanism of the present embodiment is employed, even in such a situation the client 30 can obtain the data item using the virtual URL distributed before the data movement. In addition, commonly, a data server 10 must be divided because of an increase in the amount of data to be managed. In such a situation also, according to the present embodiment, the virtual URL distributed among the users before the division can be used after the division.

In the present embodiment, because the data item can be requested using a virtual URL using the local ID having a lower number of digits as compared with the global ID, as compared with the case of a configuration using a global ID, the user can more easily memorize the virtual URL, orally tell others the virtual ID, and to input the virtual URL through typing.

In addition, in the present embodiment, when a data item is stored in the data server 10, the correspondence between the local ID of the data item within the server and the global ID is stored in the ID conversion section 13 and the information of the correspondence is not deleted even when the data item is moved to another data server. With such a configuration, even when the data item is moved between data servers, the data item can be found by transmitting an inquiry, to the data server 10 which once stored the data item, using the local ID of the data item in the data server 10.

The movement of the data item between data servers 10 is performed, for example, in the following manner. When a user inputs an instruction to move a data item stored in a data management section 12-1 of a certain data server 10-1 to another data server 10-2, the data management section 12-1 transfers the global ID of the data item to the data server 10-2 along with the data item. When the data item to be moved is designated using a local ID, the data management section 12-1 obtains the global ID of the data item using the ID conversion section 13-1 and transmits the global ID to the data server 10-2 along with the data item. The data server 10-2 receiving the data item and the global ID stores the data item in the data management section 12-2 following the procedure of FIG. 5.

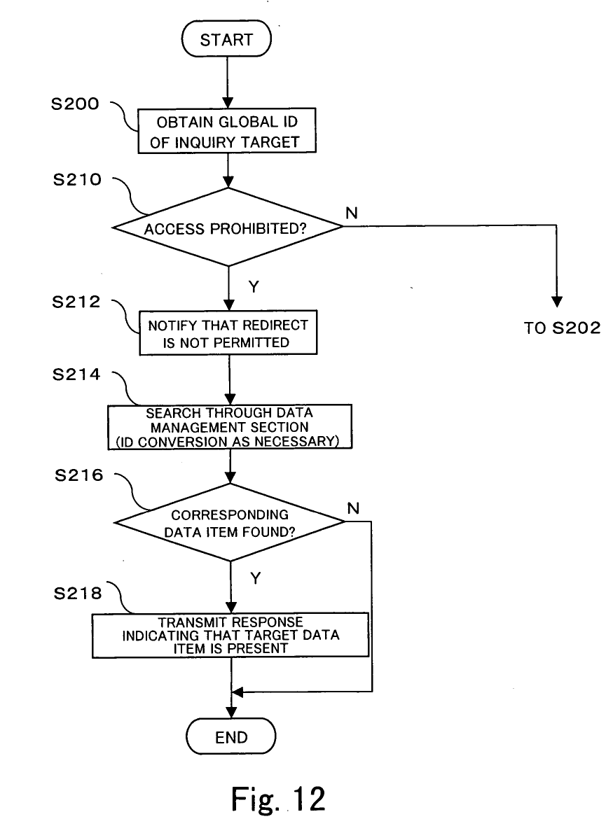

A first alternative embodiment of the embodiment will now be described by reference to FIGS. 11 and 12. As shown in FIG. 11, in the first alternative embodiment, the data server 10 has an authentication section 17. The authentication section 17 judges whether or not the user who requests the data item is allowed to access the data server 10 or the requested data item. For example, the access right of each user with respect to the data server 10 or each data item stored in the data server 10 is stored in the data server 10 or another server which can be accessed from the data server 10, and the above-described judgment is performed on the basis of the access right information. The judgment of the access right is performed not only with respect to the data request from the client 30, but also with respect to a data inquiry from another server 10. The user information (such as user ID) which forms the basis for access right determination can be obtained by, for example, the data server 10 receiving the data request from the client 30 performing a user authentication process through a method such as, for example, requesting the user to input a user ID and a password before processing the data request. When the data server 10-2 receiving the data inquiry from another data server 10-1 stores the data item, the data server 10-2 requests the data server 10-1 to transmit a user ID of the request origin. Alternatively, the user ID may be transmitted during the transmission of the data inquiry. The data server 10-2 refers to the access right information on the basis of the user ID transmitted from the inquiry origin and judges whether or not the requesting user has the right to access the data server 10-2 and the data item. When the user does not have access right to either one of the data server 10-2 and the data item, the data server 10-2 judges that the user cannot access the data item.

Another example configuration of judgment of access is as follows. Specifically, when the data server 10 limits access by the user due to, for example, periodic maintenance, the access by the user is uniformly prohibited with respect to the data inquiry from another data server 10.

The data server 10-2 which receives the inquiry may judge whether or not the access by the requesting user should be permitted, on the basis of the processing load of the data server 10-2, which is constantly monitored. More specifically, the access by the user is prohibited when the processing load is higher than a predetermined threshold value, and the access is permitted otherwise.

A processing procedure of the data server 10-2 receiving the data inquiry from another data server 10-1 is shown in FIG. 12. In this process, the data server 10-2 obtains a global ID of the target data item from the data inquiry (S200) and judges whether or not access by the requesting user to the target data item should be permitted (S210). When the access is to be permitted (that is, when the judgment result is not “access prohibition”), the process proceeds to processes of step S202 and subsequent steps in FIG. 8. When, on the other hand, the access is to be prohibited, the data server 10-2 notifies the data server 10-1 of the prohibition (S212). The data server 10-1 receiving the notification searches another data server 10 and repeats the process of transmitting a data inquiry.

The data server 10-2 may complete the process at step S212, but, in the configuration of FIG. 12, the data server 10-2 checks whether or not the target data item is stored in the data management section 12-2 of the data server 10-2 (S214) . In this process, the ID conversion section 13-2 converts the ID as necessary. When the target data item is found in the data management section 12-2 (when the determination result in step S216 is Y), the data server 10-2 notifies the data server 10-1 that the data server 10-2 has the target data item, without reporting the local ID of the target data item (S218). The data server 10-1 receiving the notification completes the search process, because the target data item is determined to be in the data server 10-2, for which the access is prohibited. The data server 10-1 may be configured to transmit, during this process, a response to the client 30 which is the request origin of the data item that a data server which cannot be accessed by the user has the requested data item.

There may alternatively be employed a configuration in which, instead of transmitting the notification indicating access prohibition to the data server 10-1 which is the inquiry origin in step S212, a notification reflecting the search result (“access prohibited and target data item present” or “access prohibited and target data item not present”) is transmitted after the search process of the data management section 12-2.

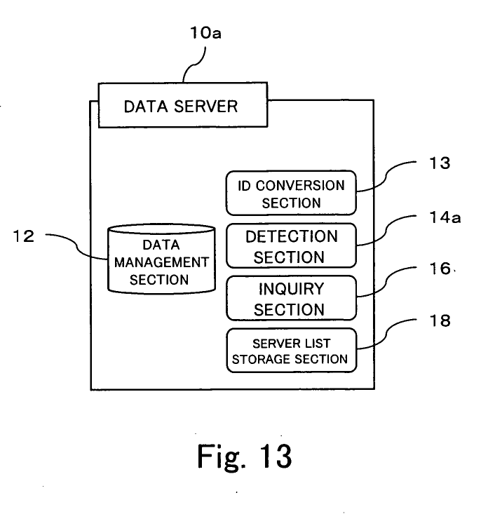

A second alternative embodiment will now be described. In the above-described embodiment, the detection section 14 detects other data servers 10 by broadcasting a predetermined message. In the second alternative embodiment, as shown in FIG. 13, each data server 10a forming a part of the data management system has a server list storage section 18 which stores a list of server IDs for other data servers 10a (hereinafter referred to as “server list”) . The server list may be stored in the server list storage section 18 by the administrator of the data server 10a or may be automatically created on the basis of a detection result through the detection method by broadcasting as described above. It is also possible to add to the server list storage section 18 information of a server list obtained from another data server 10a during processes to be described below. A detection section 14a detects another data server 10a using the server list storage section 18.

In this case, when the data server 10a-2 receiving a data inquiry from the data server 10a-1 finds that the data server 10a-2 does not have the data item which is the inquiry target, the data server 10a-2 may simply transmit a notification that the data server 10a-2 does not have the data item, or, alternatively, may transmit a response including a server ID (or a list of server IDs) within the server list storage section 18 of the server 10a-2. The server 10a-1 can expand the server list by adding to its server list storage section 18 the server ID (or the list of server IDs) received as a response.

According to the second alternative embodiment, the data server 10a can be informed of data servers 10a which are not registered in the server list storage section 18, by obtaining a server list of another data server 10a, and, therefore, the data server 10a can transmit an inquiry to the newly known data server 10a.

Alternatively, it is also possible to employ a configuration in which the data server 10a-1 detects other data servers through broadcasting when no additional data server remains in the server list storage section 18 to which the inquiry has not been transmitted in the procedure of FIG. 13, and registers the result of the detection in the server list storage section 18.

In the above-described embodiments, when the data request from the client 30 is redirected to another data server 10-2 by the request destination data server 10-1, the data server 10-2 which is the redirect destination has the requested data item. Because the redirect process is performed on the basis of the result of the data inquiry, a probability that the requested data item is present in the redirect destination is very high, but there may be cases in which the redirect destination does not have the requested data item, such as, for example, a case when the requested data item is moved from the data server 10-2 to another data server after the data inquiry is transmitted and before the redirected data request is received.

In another example configuration, each data server 10 may cache the result of the data inquiry to other data servers. More specifically, in this configuration, the data server 10 temporarily stores a server ID of a data server 10 which is determined to have the requested data item as a result of the data inquiry, in a cache memory in correspondence to the data ID of the requested data item. The data server 10 checks whether or not information of the data server having the requested data item is present in the cache memory before the data server 10 detects other data servers and transmits a data inquiry, and, when the information is found, redirects the data request to the corresponding data server. In this case also, when the cached information is old, the data server 10 derived through the redirect process may not have the requested data item.

When the redirect destination data server 10 does not have the requested data item, the redirect destination data server 10 is no different from the data server initially receiving the request, in that the redirect destination server 10 is a data server receiving a data request from a client 30. Thus, the redirect destination data server searches for a data server having the requested data item, by means of executing a processing procedure identical to that described above. In this manner, according to the present embodiment, even when the redirect destination does not have the requested data item, the redirect destination data server 10 becomes the data server receiving the request from the client 30 and the search process is recursively repeated.

The embodiment and the alternative embodiments described above can be applied not only to a situation in which the data item is moved between servers, but also to a situation in which the data item is moved within a same server and the URL is changed. For example, when the virtual URL of a data item is “http://xxx.fx.co.jp/Folderl/Folder2/uuid1,” the term “uuid1” is the global ID of the data item and “/Folder1/Folder2/” is the path of the data item within the server, “xxx.fx.co.jp.” In other words, the virtual URL is a combination of a typical location-based URL and a globally unique global ID. With such a combinational virtual URL also, the method of the above-described embodiment can be employed to search for the data item, because the virtual URL contains the global ID. In addition, because the virtual URL also contains path information of the data item within the server, the location of the data can be displayed on the basis of the location (directory), etc. (for example, a folder tree display) . When the data item “uuid1” is moved to a directory “/Folder3/Folder4/” within the same server, the accurate virtual URL would be “http://xxx.fx.co.jp/Folder3/Folder4/uuid1.” However, even when a user accesses the data item using the original virtual URL of “http://xxx.fx.co.jp/Folder1/Folder2/uuid1,” because the virtual URL contains the global ID, the user can accurately access the data item “uuid1” in the directory “/Folder3/Folder4/.” In this case, it is assumed that the link information of the data item “uuid1” in the data management section 12 is accurately updated so as to point to the data item within the directory “/Folder3/Folder4/.”

The data servers of the embodiment and the alternative embodiments are realized by executing a program describing functions and operations of the data server as described above in a general-purpose computer system. The program is typically provided in a state of being recorded on a computer-readable storage medium; for example, an optical disk such as a CD-ROM or DVD-ROM, a magnetic disk such as a flexible disk, or a hard disk drive.

According to the present invention, because each data server detects another data server, and a data server having the requested data item is searched through an inquiry using a globally unique global identifier, the location of the data item can be resolved without using a central management server. In addition, according to the present invention, even when the requested data item is specified by the client using the local identifier, a data inquiry can be transmitted to the other data servers by determining the global identifier of the requested data item by means of the correspondence storage section.

While the invention has been described in conjunction with specific embodiments, it is evident to those skilled in the art that modifications may be made thereto in light of the foregoing description. Accordingly, it is intended that the appended claims cover all such modifications that fall within the spirit and scope of the invention.

According to an aspect of the invention, a data management system having a plurality of data servers connected via a network is provided, wherein each data server includes: a data management section that manages a data item in correspondence to a local identifier of the data item and a global identifier of the data item; a request processor section that searches the data management section for a data item requested from a client, provides the requested data item to the client when the requested data item is found, and transmits a data inquiry containing a global identifier of the requested data item to other data server to detect a data server which stores the requested data item when the requested data item is not found; and a response section that searches, when receiving a data inquiry from another data server, the data management section for a data item corresponding to a global identifier contained in the data inquiry and transmits a result of the search to the another data server.

According to another aspect of the invention, each data server may further include a detection section that detects other data server which is a part of the data management system, and the request processor section may transmit the data inquiry to the other data server detected by the detection section.

According to another aspect of the invention, when the requested data item is not found in the data management section, the request processor section may transmit, to the client, information of a detected data server which stores the requested data item.

According to another aspect of the invention, when access to the data item inquired from the another data server is not permitted, the response section may respond to the another data server indicating that the access is not permitted and, when an inquired data item is found in the data management section, the response section may respond to the another data server indicating that the inquired data item has been found; and receiving from a data server which is a destination of the data inquiry a response indicating that the access to the inquired data item is not permitted and that the inquiry destination data server stores the inquired data item, the request processor section may complete detecting a data server which stores the inquired data item.

According to another aspect of the invention, each data server may further comprise an identifier assigning section that assigns a local identifier to a data item to be stored in the data management section, and a global identifier to the data item when the data item does not have an assigned global identifier.

According to another aspect of the invention, a data server which forms a part of a data management system in cooperation with other data server connected via a network is provided. The data server includes a data management section that manages a data item in correspondence to a local identifier of the data item and a global identifier of the data item; and a request processor section that searches the data management section for a data item requested from a client, provides the requested data item to the client when the requested data item is found, and transmits a data inquiry containing a global identifier of the requested data item to other data server to detect a data server which stores the requested data item when the requested data item is not found.

According to another aspect of the invention, the data server may further include a detection section that detects other data server which is a part of the data management system; wherein the request processor section may transmit the data inquiry to the other data server detected by the detection section.

According to another aspect of the invention, when the requested data item is not found in the data management section, the request processor section may transmit, to the client, information of a detected data server which stores the requested data item.

According to another aspect of the invention, when access to the data item inquired from the another data server is not permitted, the response section may respond to the another data server indicating that the access is not permitted and, when an inquired data item is found in the data management section, the response section may respond to the another data server indicating that the inquired data item has been found.

According to another aspect of the invention, the data server may further include: an identifier assigning section that assigns a local identifier to a data item to be stored in the data management section and a global identifier to the data item when the data item does not have an assigned global identifier.

According to another aspect of the invention, a data management method executed by a data server which forms a part of a data management system in cooperation with other data server connected via a network is provided. The method includes managing a data item in correspondence to a local identifier of the data item and a global identifier of the data item; searching for a data item requested from a client; providing the requested data item to the client when the requested data item is found; and transmitting a data inquiry containing a global identifier of the requested data item to other data server to detect a data server which stores the requested data item when the requested data item is not found.

According to another aspect of the invention, the data management method may further include: detecting other data server which is a part of the data management system, and transmitting the data inquiry to the other data server detected by the detection section.

According to another aspect of the invention, the data management method may further include transmitting, to the client, when the requested data item is not found, information of a detected data server which stores the requested data item.

According to another aspect of the invention, the data management method may further include: when access to the data item inquired from the another data server is not permitted, responding to the another data server indicating that the access is not permitted; and when an inquired data item is found in the data management section, responding to the another data server indicating that the inquired data item has been found.

According to another aspect of the invention, the data management method may further include: assigning a local identifier to a data item to be stored, and a global identifier to the data item when the data item does not have an assigned global identifier.

According to another aspect of the invention, a storage medium readable by a computer is provided. The storage medium stores a program of instructions executable by the computer to perform a function as a data server which forms a part of a data management system in cooperation with other data server connected via a network. The function includes: managing a data item in correspondence to a local identifier of the data item and a global identifier of the data item; searching for a data item requested from a client; providing the requested data item to the client when the requested data item is found; and transmitting a data inquiry containing a global identifier of the requested data item to other data server to detect a data server which stores the requested data item when the requested data item is not found.

According to another aspect of the invention, the function may further include: detecting other data server which is a part of the data management system, and transmitting the data inquiry to the other data server detected by. the detection section.

According to another aspect of the invention, the function may further include: transmitting to the client, when the requested data item is not found, information of a detected data server which stores the requested data item.

According to another aspect of the invention, the function may further include: when access to the data item inquired from the another data server is not permitted, responding to the another data server indicating that the access is not permitted; and when an inquired data item is found in the data management section, responding to the another data server indicating that the inquired data item has been found.

According to another aspect of the invention, the function may further include: assigning a local identifier to a data item to be stored, and a global identifier to the data item when the data item does not have an assigned global identifier.

According to another aspect of the invention, in the data management system, when the data request from the client specifies the requested data item using a local identifier, the request processor section may create the data inquiry which specifies the requested data item using a global identifier.

According to another aspect of the invention, in the data server, when the data request from the client specifies the requested data item using a local identifier, the request processor section may create the data inquiry which specifies the requested data item using a global identifier.

According to another aspect of the invention, in the data management method may further include: when the data request from the client specifies the requested data item using a local identifier, creating the data inquiry which specifies the requested data item using a global identifier.

According to another aspect of the invention, in the storage medium, the function may further include: when the data request from the client specifies the requested data item using a local identifier, creating the data inquiry which specifies the requested data item using a global identifier.

According to another aspect of the invention, in the data management system , the data management section may register a deletion operation of a stored data item, and when another data server inquires for the deleted data item, the response section may respond to the another data server indicating that the inquired data item has been deleted.

The complete disclosure of Japanese Patent Application No. 2005-162642 filed on Jun. 2, 2005, including the specification, claims, drawings, and abstract, is incorporated herein by reference in its entirety.

What is claimed is:

1. A data management system having a plurality of data servers connected via a network, wherein
each data server comprises:
a data management section that manages a data item in correspondence to a local identifier of the data item and a global identifier of the data item;
a request processor section that searches the data management section for a data item requested from a client, provides the requested data item to the client when the requested data item is found, and transmits a data inquiry containing a global identifier of the requested data item to other data server to detect a data server which stores the requested data item when the requested data item is not found; and
a response section that searches, when receiving a data inquiry from another data server, the data management section for a data item corresponding to a global identifier contained in the data inquiry and transmits a result of the search to the another data server.

2. The data management system according to claim 1, wherein
each data server further comprises a detection section that detects other data server which is a part of the data management system, and
the request processor section transmits the data inquiry to the other data server detected by the detection section.

3. The data management system according to claim 1, wherein when the requested data item is not found in the data management section, the request processor section transmits, to the client, information of a detected data server which stores the requested data item.

4. The data management system according to claim 3, wherein
when access to the data item inquired from the another data server is not permitted, the response section responds to the another data server indicating that the access is not permitted and, when an inquired data item is found in the data management section, the response section responds to the another data server indicating that the inquired data item has been found; and
receiving from a data server which is a destination of the data inquiry a response indicating that the access to the inquired data item is not permitted and that the inquiry destination data server stores the inquired data item, the request processor section completes detecting a data server which stores the inquired data item.

5. The data management system according to claim 1, wherein each data server further comprises an identifier assigning section that assigns a local identifier to a data item to be stored in the data management section, and a global identifier to the data item when the data item does not have an assigned global identifier.

6. A data server which forms a part of a data management system in cooperation with other data server connected via a network, the data server comprising:
a data management section that manages a data item in correspondence to a local identifier of the data item and a global identifier of the data item; and
a request processor section that searches the data management section for a data item requested from a client, provides the requested data item to the client when the requested data item is found, and transmits a data inquiry containing a global identifier of the requested data item to other data server to detect a data server which stores the requested data item when the requested data item is not found.

7. The data server according to claim 6, further comprising:
a detection section that detects other data server which is a part of the data management system; wherein the request processor section transmits the data inquiry to the other data server detected by the detection section.

8. The data server according to claim 6, wherein
when the requested data item is not found in the data management section, the request processor section transmits, to the client, information of a detected data server which stores the requested data item.

9. The data server according to claim 8, wherein
when access to the data item inquired from the another data server is not permitted, the response section responds to the another data server indicating that the access is not permitted and, when an inquired data item is found in the data management section, the response section responds to the another data server indicating that the inquired data item has been found.

10. The data server according to claim 6, further comprising:
an identifier assigning section that assigns a local identifier to a data item to be stored in the data management section and a global identifier to the data item when the data item does not have an assigned global identifier.

11. A data management method executed by a data server which forms a part of a data management system in cooperation with other data server connected via a network, the method comprising:
managing a data item in correspondence to a local identifier of the data item and a global identifier of the data item;
searching for a data item requested from a client;
providing the requested data item to the client when the requested data item is found; and
transmitting a data inquiry containing a global identifier of the requested data item to other data server to detect a data server which stores the requested data item when the requested data item is not found.

12. The data management method according to claim 11, further comprising:
detecting other data server which is a part of the data management system, and
transmitting the data inquiry to the other data server detected by the detection section.

13. The data management method according to claim 11, wherein
transmitting, to the client, when the requested data item is not found, information of a detected data server which stores the requested data item.

14. The data management method according to claim 13, further comprising:
when access to the data item inquired from the another data server is not permitted, responding to the another data server indicating that the access is not permitted; and
when an inquired data item is found in the data management section, responding to the another data server indicating that the inquired data item has been found.

15. The data management method according to claim 11, further comprising:
assigning a local identifier to a data item to be stored, and a global identifier to the data item when the data item does not have an assigned global identifier.

16. A storage medium readable by a computer, the storage medium storing a program of instructions executable by the computer to perform a function as a data server which forms a part of a data management system in cooperation with other data server connected via a network, the function comprising:
managing a data item in correspondence to a local identifier of the data item and a global identifier of the data item;
searching for a data item requested from a client;
providing the requested data item to the client when the requested data item is found; and
transmitting a data inquiry containing a global identifier of the requested data item to other data server to detect a data server which stores the requested data item when the requested data item is not found.

17. The storage medium according to claim 16, the function further comprising:
detecting other data server which is a part of the data management system, and
transmitting the data inquiry to the other data server detected by the detection section.

18. The storage medium according to claim 16, the function further comprising:
transmitting to the client, when the requested data item is not found, information of a detected data server which stores the requested data item.

19. The storage medium according to claim 18, the function further comprising:
when access to the data item inquired from the another data server is not permitted, responding to the another data server indicating that the access is not permitted; and
when an inquired data item is found in the data management section, responding to the another data server indicating that the inquired data item has been found.

20. The storage medium according to claim 16, the function further comprising:
assigning a local identifier to a data item to be stored, and a global identifier to the data item when the data item does not have an assigned global identifier.

21. The data management system according to claim 1, wherein:
when the data request from the client specifies the requested data item using a local identifier, the request processor section creates the data inquiry which specifies the requested data item using a global identifier.

22. The data server according to claim 6, wherein:
when the data request from the client specifies the requested data item using a local identifier, the request processor section creates the data inquiry which specifies the requested data item using a global identifier.

23. The data management method according to claim 11, further comprising:
when the data request from the client specifies the requested data item using a local identifier, creating the data inquiry which specifies the requested data item using a global identifier.

24. The storage medium according to claim 16, the function further comprising:
when the data request from the client specifies the requested data item using a local identifier, creating the data inquiry which specifies the requested data item using a global identifier.

25. The data management system according to claim 1, wherein the data management section registers a deletion operation of a stored data item, and
when another data server inquires for the deleted data item, the response section responds to the another data server indicating that the inquired data item has been deleted.
